(19) United States
(12) Patent Application Publication
(10) Pub. No.: US 2016/0057542 A1
(43) Pub. Date: Feb. 25, 2016

(54) DATA TRANSMISSION FROM SPEAKERS USING MAGNETIC FLUX COUPLING

(71) Applicant: Richard Edward Pasek, Brookline, MA (US)

(72) Inventor: Richard Edward Pasek, Brookline, MA (US)

(21) Appl. No.: 14/835,678

(22) Filed: Aug. 25, 2015

Related U.S. Application Data
(60) Provisional application No. 62/041,273, filed on Aug. 25, 2014.

(51) Int. Cl. H04R 9/02

(52) U.S. Cl. CPC H04R 9/025

(57) ABSTRACT

Disclosed are various embodiments for data transmission from speakers using magnetic flux coupling. A speaker driver of a first device transmits a magnetic flux signal encoding configuration information. A magnetic flux detector of a second device receives the magnetic flux signal. A processor of the second device demodulates the magnetic flux signal to recover the configuration information. At least one operational parameter of the second device is configured using the configuration information.

### CROSS-REFERENCE TO RELATED APPLICATIONS

The present application claims the benefit of U.S. Provisional Application No. 62/041,273 entitled “DATA TRANSMISSION USING MAGNETIC FLUX COUPLING” and filed on Aug. 25, 2014, which is incorporated herein by reference in its entirety.

### BACKGROUND

Connecting most Wi-Fi enabled Internet of Things (IoT) devices to the Internet is too complicated for the average user. On most IoT devices, the setup procedure is as follows:

Step 1. Power on the IoT device.

Step 2. Connect to the Wi-Fi network created by the IoT device.

Step 3. Navigate to a configuration page hosted by the IoT device using a web browser.

Step 4. Enter the SSID and passkey for the network to which the IoT device should connect.

Step 5. The IoT device uses the specified SSID and passkey to connect to the appropriate network.

Although this procedure may work, many situations may arise where the user may become confused. Specifically, users may become confused by having to connect to a new Wi-Fi network and having to select their original Wi-Fi network in the web browser immediately after switching away from their original network. The setup of IoT devices and potentially other devices could be simplified by alleviating the need to connect to a different Wi-Fi Network.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked sensor device according to various embodiments of the present disclosure.

FIG. 2A is a schematic block diagram of a receiver device, such as the networked sensor device of FIG. 1, according to various embodiments of the present disclosure.

FIG. 2B is a schematic block diagram of a transmitter device according to various embodiments of the present disclosure.

FIG. 3 is a flowchart illustrating one example of functionality implemented as portions of the transmitter device of FIG. 2B according to various embodiments of the present disclosure.

FIG. 4 is a flowchart illustrating one example of functionality implemented as portions of the receiver device of FIG. 2A according to various embodiments of the present disclosure.

### DETAILED DESCRIPTION

The present disclosure relates to using magnetic flux coupling for receiving data transmitted by a speaker in an ultrasonic range. Sound processors in most mobile devices have the capability of generating frequencies in the range of 0 to 22,050 Hz. The range of human hearing is generally given as 20 Hz to 20,000 Hz, but most adults can only hear to 18,000 Hz. 20,000 Hz is almost completely inaudible to children. This leaves approximately a 2,050 Hz range (between 20,000 Hz and 22,050 Hz) that humans realistically cannot hear and could be very useful for transferring data.

One approach to setting up IoT devices may involve acoustically coupled data transmission in the ultrasonic range. Unfortunately, data cannot be passed very quickly or reliably using this method because of background noise and sound reflecting on surfaces in a room. Filtering sound reflections is also not suitable for many devices as it is very processor intensive process. The hardware necessary for acoustic coupling may add unacceptably to the cost of an IoT device. Furthermore, some speakers are not of high enough quality to create ultrasonic sounds that can transfer data effectively.

Various embodiments of the present disclosure facilitate data transmission by picking up the inductance or flux generated by a speaker using a magnetic pickup coil or inductor. This approach can work with any electromagnetic speaker, as opposed to capacitive speakers. This essentially creates an air-coupled transformer with the drive coil of the speaker. With this approach, speaker quality is irrelevant, as the speaker coil is being read directly irrespective of whether the speaker can actually reproduce the driven acoustic sound. Because the only major magnetic field in the immediate vicinity is generated by the speaker, almost no noise exists. Because sound is not used, there are no surface reflections or background noise to filter for. This allows for high data rates with low processing power requirements. The only tradeoff is range, which, in one embodiment, may be approximately four inches from the speaker.

In one embodiment, the pickup coil is tuned to approximately 20,500 Hz using a matched bias capacitor to create a resonant tank circuit. For example, audio frequency-shift keying (AFSK) may be employed. 20,000 Hz and 21,000 Hz may be selected to represent digital 0 and 1, respectively. Other frequencies between 20,000 Hz and 22,000 Hz may be selected to represent additional symbols to increase data transfer rate irrespective of baud rate. In other embodiments, amplitude-shift keying (ASK), phase-shift keying (PSK), quadrature amplitude modulation (QAM), trellis-coded modulation, and/or other modulation approaches may be employed to encode the data.

The output of this circuit may be fed into an operational amplifier with an active filter. This output may then be sent to another operational amplifier set to maximum gain. Because the gain is so high, the operational amplifier may act like a comparator outputting a digital signal. The signal may be treated as a digital signal and fed directly into an interrupt pin on a microcontroller. The time between rising and/or falling edges may be measured, determining frequency. This alleviates the need for complex zero crossing circuits or a processor which can perform Fast Fourier Transformation (FFT) calculations to determine frequency.

The changes in frequency may be done relatively slowly, at about 100 Hz per cycle or half cycle. In experiments, direct changes between 20,000 Hz and 21,000 Hz seemed to create an audible 1,000 Hz sound during frequency changes, which may be highly irritating to the hearer. The final frequency may be held for a few cycles for the receiving microcontroller to recognize the final frequency and determine a value.

In one scenario, the above described magnetic flux coupling may be included within an IoT device in order to receive network configuration data transmitted by another device, e.g., a smartphone, a tablet, a laptop, a desktop, a game console, and/or any other device having a suitable speaker from which the magnetic flux/inductance can be picked up. Upon receiving the configuration data, the IoT device may then connect to other IoT devices via a Wi-FI network or other network. Various examples of networked sensor devices in which such a magnetic flux coupling may be included are described in U.S. patent application Ser. No. 13/838,776, entitled “NETWORKED SENSOR DEVICE,” and filed on Mar. 15, 2013, which is incorporated herein by reference in its entirety. The use of such a magnetic flux coupling may facilitate creating a waterproof housing for the networked sensor device by avoiding ports and/or other protrusions that are difficult to waterproof.

Generally, this magnetic flux coupling approach results in unidirectional communication, between a first general-purpose device having a speaker and a second device having the magnetic flux pickup described herein. However, it may be useful to provide signaling back from the second device to the first device. For example, the second device may emit a beep or other audio signal that can be sensed by a microphone on the first device. Such a signal may indicate receipt of the transmitted data.

In transmitting data, a header may be used for framing purposes. A battery-operated receiving device may be shipped in a low-power listening state, and detection of the header may wake the device automatically by triggering an interrupt. The header and payload data may be repeated continuously during a transmission periodically, especially if there is not a return path to signal that the payload data has been received correctly.

In one embodiment, error detection is provided by way of a checksum transmitted with the payload data. For example, when the data being transmitted comprises a sequence of eight-bit values, a sixteen-bit checksum may be transmitted. The checksum corresponds to a sum of the sequence of eight-bit values, and may include one or more overflows or resets.

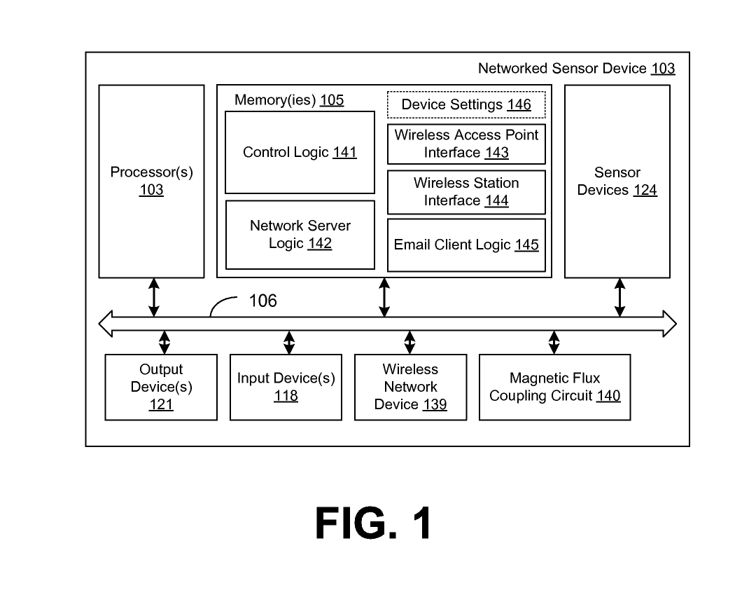

With reference to FIG. 1, shown is a schematic block diagram of the networked sensor device 103 according to an embodiment of the present disclosure. The networked sensor device 103 includes at least one processor circuit, for example, having a processor 104 and a memory 105, both of which are coupled to a local interface 106. The local interface 106 may also be coupled to input device(s) 118, output device(s) 121, sensor devices 124, a wireless network device 139, a magnetic flux coupling circuit 140, and/or other hardware systems. The local interface 106 may comprise, for example, a data bus with an accompanying address/control bus or other bus structure as can be appreciated.

Stored in the memory 105 are both data and several components that are executable by the processor 104. In particular, stored in the memory 105 and executable by the processor 104 are control logic 141, network server logic 142, a wireless access point interface 143, a wireless station interface 144, email client logic 145, and potentially other systems. Also stored in the memory 105 may be device settings 146 and other data. In addition, an operating system may be stored in the memory 105 and executable by the processor 104.

It is understood that there may be other applications that are stored in the memory 105 and are executable by the processor 104 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory 105 and are executable by the processor 104. In this respect, the term “executable” means a program file that is in a form that can ultimately be run by the processor 104. Examples of executable programs may be, for example, a compiled program that can be translated into machine code in a format that can be loaded into a random access portion of the memory 105 and run by the processor 104, source code that may be expressed in proper format such as object code that is capable of being loaded into a random access portion of the memory 105 and executed by the processor 104, or source code that may be interpreted by another executable program to generate instructions in a random access portion of the memory 105 to be executed by the processor 104, etc. An executable program may be stored in any portion or component of the memory 105 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 105 is defined herein as including both volatile and nonvolatile memory and data storage components. Volatile components are those that do not retain data values upon loss of power. Nonvolatile components are those that retain data upon a loss of power. Thus, the memory 105 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 104 may represent multiple processors 104 and the memory 105 may represent multiple memories 105 that operate in parallel processing circuits, respectively. In such a case, the local interface 106 may be an appropriate network that facilitates communication between any two of the multiple processors 104, between any processor 104 and any of the memories 105, or between any two of the memories 105, etc. The local interface 106 may comprise additional systems designed to coordinate this communication, including, for example, performing load balancing. The processor 104 may be of electrical or of some other available construction.

Although the control logic 141, the network server logic 142, the wireless access point interface 143, the wireless station interface 144, the email client logic 145, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Also, any logic or application described herein, including the control logic 141, the network server logic 142, the wireless access point interface 143, the wireless station interface 144, and the email client logic 145, that comprises software or code can be embodied in any non-transitory computer-readable medium for use by or in connection with an instruction execution system such as, for example, a processor 104 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

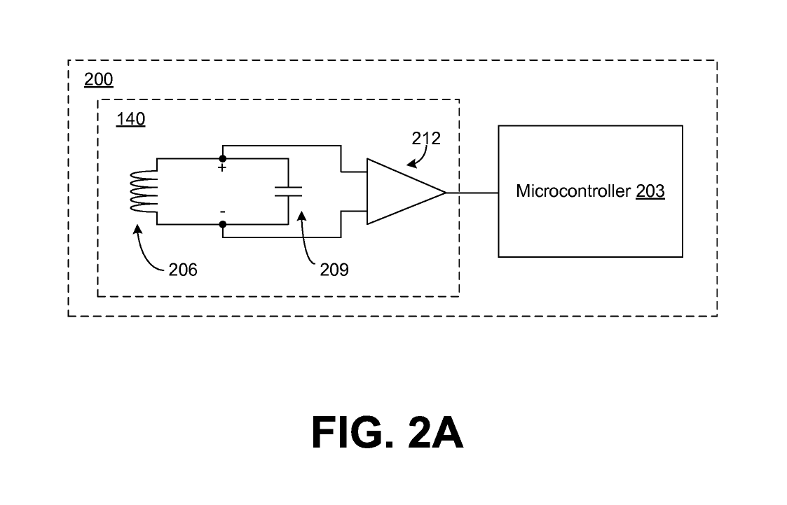

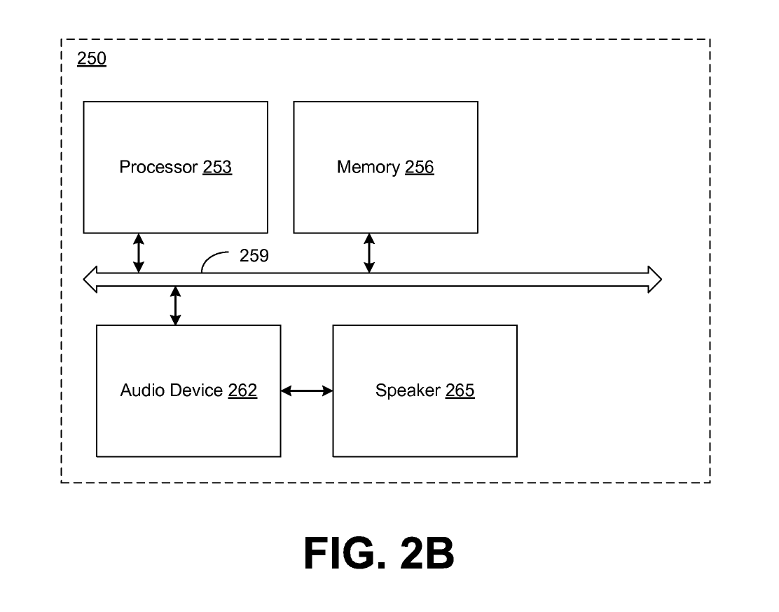

Moving on to FIG. 2A, shown is one example of a receiver device 200 in accordance with an embodiment of the present disclosure. Among other components, the receiver device 200 may include a microcontroller 203 and a magnetic flux coupling circuit 140. The magnetic flux coupling circuit 140 may comprise an inductor 206 and a matched capacitor 209 in a resonant tank circuit arrangement configured to receive signals at frequencies approximately between 20,000 Hz and 22,050 Hz. The output of the resonant tank circuit is provided to one or more operational amplifiers 212. The output of the magnetic flux coupling circuit 140 may be coupled to a pin of the microcontroller 203, which may be an interrupt pin, a comparator input pin, or another pin.

Turning now to FIG. 2B, shown is a schematic block diagram of a transmitter device 250 according to an embodiment of the present disclosure. The transmitter device 250 includes at least one processor circuit, for example, having a processor 253 and a memory 256, both of which are coupled to a local interface 259. The local interface 259 may also be coupled to an audio device 262, such as a sound card, sound chip, or other device capable of receiving audio samples and generating an electrical signal corresponding to the sound samples. The audio device 262 is configured to drive a speaker 265. The speaker 265 is electromagnetically driven, such that in addition to audio generated by vibration of a cone, incidental magnetic flux is created by the driver of the speaker 265. While the audio frequency response of the speaker 265 may fall off dramatically at high frequencies (e.g., greater than 18,000 Hz), the frequency response of the magnetic flux is not similarly affected.

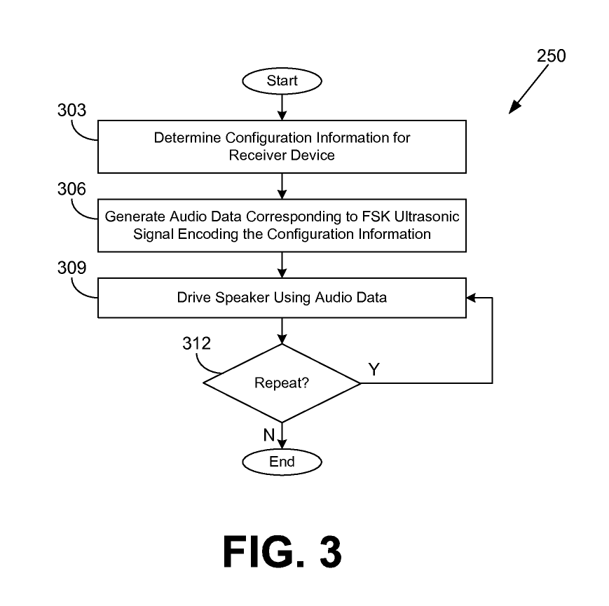

Referring next to FIG. 3, shown is a flowchart that provides one example of the operation of a portion of the transmitter device 250 according to various embodiments. It is understood that the flowchart of FIG. 3 provides merely an example of the many different types of functional arrangements that may be employed to implement the operation of the portion of the transmitter device 250 as described herein. As an alternative, the flowchart of FIG. 3 may be viewed as depicting an example of elements of a method implemented in the transmitter device 250 according to one or more embodiments.

Beginning with box 303, the transmitter device 250 determines configuration information for a receiver device 200 (FIG. 2A). For example, the configuration information may configure one or more parameters for operation of a wireless network device 139 (FIG. 1), a wireless access point interface 143 (FIG. 1), a wireless station interface 144 (FIG. 1), or other components of a receiver device 200 such as the networked sensor device 103 (FIG. 1).

In box 306, the transmitter device 250 generates audio data corresponding to a frequency-shift-keyed ultrasonic signal that encodes the configuration information. The ultrasonic signal may be greater than 19,000 Hz. However, the ultrasonic signal may be less than 22,050 Hz, which is the greatest frequency that can be reproduced given the common sampling rate of 44,100 Hz for most audio devices. The audio data may include a header signal. In box 309, the transmitter device 250 drives the speaker 265 (FIG. 2B) using the audio data by way of the audio device 262 (FIG. 2B). Although the speaker 265 is driven, little to no audio may be reproduced because the speaker 265 may be incapable of accurately reproducing the ultrasonic signal.

In box 312, the transmitter device 250 determines whether to repeat the transmission. In some cases, the transmission may be repeated a standard number of times or for a given duration. In other cases, the transmission may be repeated until a confirmation is received from the receiver device 200 (e.g., detecting, by a microphone, a “beep” or other sound generated by the receiver device 200). If the transmission is to be repeated, the transmitter device 250 returns to box 309 and drives the speaker 265 using the same audio data. Otherwise, the operation of the portion of the transmitter device 250 ends.

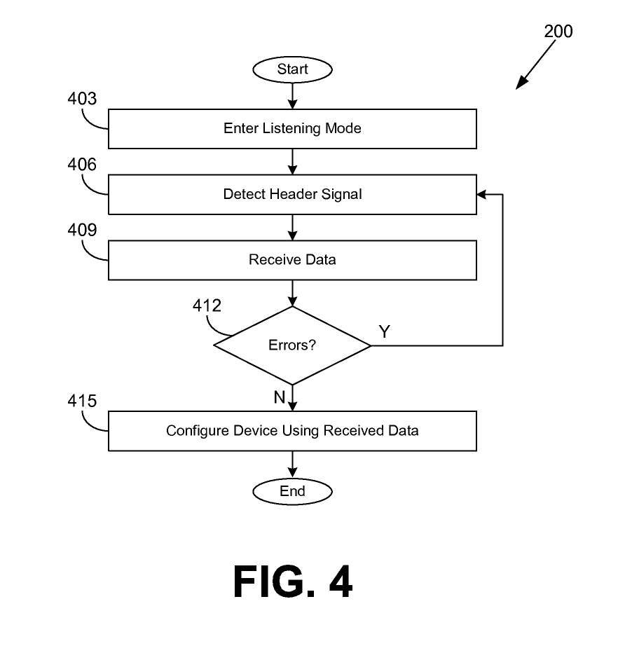

Referring next to FIG. 4, shown is a flowchart that provides one example of the operation of a portion of the receiver device 200 according to various embodiments. It is understood that the flowchart of FIG. 4 provides merely an example of the many different types of functional arrangements that may be employed to implement the operation of the portion of the receiver device 200 as described herein. As an alternative, the flowchart of FIG. 4 may be viewed as depicting an example of elements of a method implemented in the receiver device 200 according to one or more embodiments.

Beginning with box 403, the receiver device 200 enters a listening mode. In box 406, the receiver device 200 detects a header signal via the magnetic flux coupling circuit 140. Receiving such a header signal may cause the receiver device 200 to wake from a sleep mode that conserves power. The receiver device 200 may be positioned within six inches of the transmitter device 250 in order to receive the corresponding magnetic flux signal. In box 409, the receiver device 200 receives data. In box 412, the receiver device 200 determines whether the data includes errors. For example, the data may include a checksum field. A checksum may be performed on the received data and then compared to the received value in the checksum field. If they are not identical, an error has occurred. If an error is detected, the receiver device 200 may return to box 406 and redetect the header signal and re-receive the data from the transmitter device 250.

If no errors are found, the receiver device 200 continues from box 412 to box 415. In box 415, the receiver device 200 configures an operational parameter of the receiver device 200 using at least a portion of the received data. For example, the operational parameter may enable the receiver device 200 to communicate wirelessly with another device. The receiver device 200 may also generate a signal indicating to the transmitter device 250 that the configuration information has been received. Thereafter, the operation of the portion of the receiver device 200 ends.

Although the flowcharts of FIGS. 3 and 4 show a specific order of execution, it is understood that the order of execution may differ from that which is depicted. For example, the order of execution of two or more blocks may be scrambled relative to the order shown. Also, two or more blocks shown in succession in FIGS. 3 and 4 may be executed concurrently or with partial concurrence. Further, in some embodiments, one or more of the blocks shown in FIGS. 3 and 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A mobile device, comprising:
a magnetic flux detector; and
a microcontroller coupled to the magnetic flux detector, wherein the microcontroller is configured to receive, via the magnetic flux detector, configuration information encoded in a signal emitted by a speaker driver.

2. The mobile device of claim 1, wherein the magnetic flux detector comprises a resonant tank circuit tuned to receive frequencies corresponding to an ultrasonic audio signal.

3. The mobile device of claim 2, wherein the ultrasonic audio signal corresponds to frequencies approximately between 19,000 Hz and 22,050 Hz.

4. The mobile device of claim 1, wherein the signal emitted by the speaker driver is a frequency-shift-keyed (FSK) signal.

5. The mobile device of claim 1, wherein the magnetic flux detector is coupled to the microcontroller at an interrupt pin of the microcontroller.

6. The mobile device of claim 1, wherein the microcontroller is configured to wake from a sleep mode upon detection of a header portion of the signal by the magnetic flux detector.

7. The mobile device of claim 1, wherein the magnetic flux detector comprises an operational amplifier coupled to a resonant tank circuit, and the microcontroller comprises a comparator coupled to an output of the operational amplifier.

8. A system, comprising:
a transmitting device configured to generate an ultrasonic signal via a speaker and a corresponding magnetic flux signal via a driver of the speaker; and
a receiving device configured to receive the corresponding magnetic flux signal via a magnetic flux detector, wherein the corresponding magnetic flux signal bears configuration information for the receiving device.

9. The system of claim 8, wherein the speaker of the transmitting device is incapable of accurately reproducing the ultrasonic signal.

10. The system of claim 8, wherein the receiving device is positioned within six inches of the transmitting device in order to receive the corresponding magnetic flux signal.

11. The system of claim 8, wherein the receiving device includes a wireless local area network (WLAN) interface, and the configuration information includes a parameter that configures operation of the WLAN interface.

12. The system of claim 8, wherein the magnetic flux detector comprises a resonant tank circuit including an inductor and a matched bias capacitor.

13. The system of claim 8, wherein the receiving device comprises a processor coupled to the magnetic flux detector.

14. The system of claim 8, wherein the receiving device is further configured to generate a signal indicating to the transmitting device that the configuration information has been received.

15. A method, comprising:
transmitting, by a speaker driver of a first device, a magnetic flux signal encoding configuration information;
receiving, by a magnetic flux detector of a second device, the magnetic flux signal;
demodulating, by a processor of the second device, the magnetic flux signal to recover the configuration information; and
configuring an operational parameter of the second device using the configuration information.

16. The method of claim 15, wherein the configuration information is repeated a plurality of times in the magnetic flux signal.

17. The method of claim 15, further comprising incidentally generating, by a speaker of the first device, an ultrasonic audio signal corresponding to a portion of the magnetic flux signal.

18. The method of claim 15, wherein the operational parameter enables the second device to communicate wirelessly with at least one other device.

19. The method of claim 15, further comprising exiting a sleep mode of the second device in response to detecting, by the magnetic flux detector, a header portion of the magnetic flux signal.

20. The method of claim 15, wherein the magnetic flux signal is a frequency-shift-keyed (FSK) signal that alternates among a plurality of ultrasonic frequencies below 22,050 Hz.
